(19) United States
(12) Patent Application Publication
(10) Pub. No.: US 2025/0029821 A1
(43) Pub. Date: Jan. 23, 2025

(54) AURORAL SUBSTORM SIMULATION METHOD AND DYNAMIC MODEL BASED ON NEUTRAL ATOM IMAGING MEASUREMENT

(71) Applicant: National Space Science Center, Chinese Academy of Sciences, Beijing (CN)

(72) Inventors: Li LU, Beijing (CN); Qinglong Yu, Beijing (CN); Shuai Jia, Beijing (CN); Zhong Xie, Beijing (CN); Jian Lan, Beijing (CN); Jinfa Shao, Beijing (CN)

(21) Appl. No.: 18/777,294

(22) Filed: Jul. 18, 2024

(30) Foreign Application Priority Data
Jul. 21, 2023 (CN) 2023109009180

(51) Int. Cl. H01J 49/00; H01J 49/06

(52) U.S. Cl. CPC H01J 49/0004; H01J 49/0036; H01J 49/062

(57) ABSTRACT

The present invention relates to the technical field of geomagnetic activities, and in particular to an auroral substorm simulation method and macroscopic model based on neutral atom imaging measurement. The method includes the following steps: establishing a neutral atom imaging simulation equation for dynamic evolution of ion flux distribution of a ring current guided by ion pitch angle diffusion; and using the neutral atom imaging simulation equation, forward modeling neutral atom simulation images in an ecliptic plane corresponding to different ion pitch angle distribution functions during a geomagnetically quiet period and during an auroral substorm period to reproduce ring current ion flux distribution patterns in a growth phase stage and a recovery phase stage of an auroral substorm process. The present invention can emulate and reproduce ring current ion flux distribution patterns in a growth phase stage and a recovery phase stage of an auroral substorm process, which lays a foundation for further research.

### TECHNICAL FIELD

The present invention relates to the technical field of geomagnetic activities, in particular, to an auroral substorm simulation method and dynamic model based on neutral atom imaging measurement.

### BACKGROUND

Geomagnetic substorms are caused by magnetospheric perturbation by solar wind bow shock, but an energy transfer process of a specific auroral substorm event, and causal timing of the process involving a core node event are still unsolved problems being explored in magnetospheric physics. Previous studies focus on magnetotail lobe reconnection induced by solar wind particle stream, magnetopause reconnection caused by southward orientation of an interplanetary magnetic field, as well as pitch angle diffusion of energy ions during magnetotail deformation caused by dynamic pressure of solar wind, etc., which are directed to different substorm triggering mechanisms, respectively. Since space plasma distribution is invisible under current technical conditions, and a global view is not provided in in-situ measurement, it has been difficult to reach a definitive conclusion on the above problem.

Neutral atom imaging technology uses tracer particle properties of ENAs (Energy Neutral Atoms) to visualize space plasma distribution, opening up new ways for the study of this problem. However, an inclination angle of a previous neutral atom imaging measurement orbit is large, and an ENA signal for measurement mainly originates from a high-latitude, low-altitude auroral zone region, making it impossible to implement dynamic monitoring of a substorm process.

### SUMMARY OF THE INVENTION

An object of the present invention is to overcome the problem in the existing neutral atom imaging technology that a large inclination angle of an imaging measurement orbit makes it impossible to implement dynamic monitoring of an auroral substorm process, and thereby provide an auroral substorm simulation method and dynamic model based on neutral atom imaging measurement.

In order to solve the above technical problem, the auroral substorm simulation method based on neutral atom imaging measurement provided in the technical solution of the present invention includes the following steps:
establishing a neutral atom imaging simulation equation for dynamic evolution of ion flux distribution of a ring current guided by ion pitch angle diffusion; and
using the neutral atom imaging simulation equation, forward modeling neutral atom simulation images in an ecliptic plane corresponding to different ion pitch angle distribution functions during a geomagnetically quiet period and during an auroral substorm period to reproduce ring current ion flux distribution patterns in a growth phase stage and a recovery phase stage of an auroral substorm process.

As an improvement of the above method, establishing a neutral atom imaging simulation equation for dynamic evolution of ion flux distribution of a ring current guided by ion pitch angle diffusion specifically includes the following steps: expressing counts C(δ, ε) elevation angle δ and azimuth angle ε recorded in each pixel of neutral atom images, in the neutral atom image simulation equation:

$$\\ C ( δ , ε ) = \int Δ E Δ T Δ Ω {j}_{ion} ( L , φ , θ , E , α ) A ( δ , ε ) σ ( E ) n ( r , φ , θ ) dV ,$$

wherein ΔE is an ion energy channel width; ΔT is an integration time of the pixel; ΔΩ is a solid angle of a volume element pointing to the pixel with the elevation angle δ and the azimuth angle ε; Jᵢₒₙ(L, φ, θ, E, α) is an ion differential flux at the integration volume element; A(δ, ε) is a response function of a detector; σ(E) is a charge-exchange cross-section; n(r, φ,θ) is an exosphere neutral atom density, where r is a geocentric distance, φ is a local time, θ is a magnetic latitude; dV is a volume element integral along a line-of-sight direction of the detector, L is a magnetic shell index, E is energy, and α is an ion pitch angle within a magnetospheric neutral atom image emitter element.

As an improvement of the above method, the ion differential flux Jᵢₒₙ(L, φ, θ, E, α) at the integration volume element is:

$$\\ {j}_{ion} ( L , φ , θ , E , α ) = {ej}_{max 0}^{{}_{} eq} ( φ , L , {α}_{eq} ) \frac{E}{{E}_{max 0}} {( 1 + \frac{E}{κ {E}_{max 0}} )}^{- κ - 1} ,$$

where L is a magnetic shell parameter, φ is a local time, θ is a magnetic latitude, E is energy, α is an ion pitch angle within a magnetospheric neutral atom image emitter element, α_{eq} is a pitch angle of equatorial ions; κ=5.5; and E_{max 0} is an initial value of energy at which a ring current ion flux is maximum;

$$\\ e = {( 1 + 1 / κ )}^{κ + 1} , {j}_{max 0}^{{}_{} eq} ( φ , L , {α}_{eq} ) = {J}_{0}^{{}_{} eq} exp \{ - ( {f}_{φ} + {f}_{L} + {f}_{α} ) \} ,$$

where j_{max 0}^{eq}(φ, L, α_{eq}g)=6×10⁶ cm⁻²sr⁻¹KeV⁻¹s⁻¹, and J₀^{eq} is an equatorial ion flux;
f_{φ} is a local time distribution function of the ring current ion flux:

$$\\ {f}_{φ} = ξ [ 1 - cos ( φ - {φ}_{s} ) ] ,$$

where φₛ=180°, ξ=0.73, and the local time φ of the ring current ion flux is in symmetric distribution;

f_{L} is a magnetic shell parameter distribution function of the ring current ion flux:

$$\\ {f}_{L} = \{ \begin{matrix}{{γ}_{1} ( L - {L}_{11} )}^{2} , & L < {L}_{11} \\ γ ( L - {L}_{11} ) , & {L}_{11} \leq L \leq {L}_{22} \\ {{γ}_{2} ( L - {L}_{22} )}^{2} + γ ( {L}_{22} - {L}_{11} ) , & L > {L}_{22}\end{matrix} ,$$

where L is a magnetic shell parameter, L₁₁ is a first boundary value of a ring current, L₂₂ is a second boundary value of the ring current, γ₁ is a first model parameter, γ₂ is a second model parameter, and γ is a third model parameter, where

$$\\ {L}_{11} = \frac{122 - 10 {K}_{p 11}}{24 - 7.3} ; {L}_{22} = \frac{122 - 10 {K}_{p 22}}{24 - 7.3} ,$$

where Kₚ₁₁ is a first geomagnetic activity index, Kₚ₂₂ is a second geomagnetic activity K index, Kₚ₁₁=5.5, and Kₚ₂₂=0;
f₆₀ is a pitch angle distribution function of ring current ions;

$$\\ {f}_{α} = \{ \begin{matrix}{K}_{α} {cos}^{{}_{} 2} {α}_{eq} , & ( {K}_{α} = 3 ) \\ {K}_{α} {cos}^{{}_{} 2} {α}_{eq} , & ( {K}_{α} = 1 ) \\ {K}_{α} {cos}^{{}_{} 2} 2 {α}_{eq} , & ( {K}_{α} = 1 ) \\ {K}_{α} {sin}^{{}_{} 2} {α}_{eq} , & ( {K}_{α} = 3 )\end{matrix} ,$$

where the ion pitch angle α within a magnetospheric neutral atom image emitter element is expressed by the pitch angle α_{eq} of equatorial ions.

As an improvement of the above method, the first model parameter γ₁ takes a value of 0.53, the second model parameter γ₂ takes a value of 0.88, and the third model parameter Y takes a value of 1.16.

As an improvement of the above method, the exosphere neutral atom density n(r, φ, θ) is:

$$\\ n ( r , φ , θ ) = {n}_{0} ( exp ( 17.5 exp ( - 1.5 r ) - \frac{r}{1.46 ( 1 - 0.3 sin θ cos φ )} ) + {( \frac{{a}_{0}}{r} )}^{2} )$$

wherein a radial flux of neutral atoms is set to be conserved during strong geomagnetic storms, n₀ is a neutral density constant and takes a value of 1600 cm⁻³, exp represents an exponential function, r is a geocentric distance, the geocentric distance r is in units of exosphere height R_{E}, θ is a magnetic latitude, and φ is a local time, with a₀=1.78.

As an improvement of the above method, the neutral atom images are recorded by an energetic neutral atom imager;
the energetic neutral atom imager records the neutral atom images after charge exchange between energy ions precipitated into an auroral region by an equatorial ring current and low-energy neutral atoms evaporating from an exosphere; and
a minimum energy channel of the energetic neutral atom imager is 4 keV.

As an improvement of the above method, after forward modeling neutral atom simulation images in an ecliptic plane corresponding to different ion pitch angle distribution functions during a geomagnetically quiet period and during an auroral substorm period, the method further includes the following steps:
measuring and evaluating flux distribution, mass and energy spectra of energy ions stored in a ring current region by using the neutral atom simulation images in the ecliptic plane during the geomagnetically quiet period; and
based on results of measuring and evaluating the flux distribution, mass and energy spectra of the energy ions stored in the ring current region by using the neutral atom simulation images in the ecliptic plane during the geomagnetically quiet period, monitoring reduction of energetic neutral atom flux in the ring current region and enhancement of energetic neutral atom flux in an auroral zone region during a solar wind bow perturbation growth phase stage and corresponding AE index changes to evaluate an acceleration process of auroral substorm precipitated ions and analyze a corresponding acceleration mechanism.

As an improvement of the above method, after forward modeling neutral atom simulation images in an ecliptic plane corresponding to different ion pitch angle distribution functions during a geomagnetically quiet period and during an auroral substorm period, the method further includes the following step: during the recovery phase stage of the auroral substorm process, by using neutral atom images, monitoring energy neutral atom flux changes in an auroral zone region and a ring current region, and monitoring components and an energy spectrum of energy ions injected into the ring current during a magnetic field dipolarization process to evaluate precipitation loss and injection renewal of ring current energy ions during the auroral substorm process.

As an improvement of the above method, after forward modeling neutral atom simulation images in an ecliptic plane corresponding to different ion pitch angle distribution functions during a geomagnetically quiet period and during an auroral substorm period, the method further includes the following step: evaluating a probability of continuous auroral substorms based on a ring current ion flux distribution pattern in the recovery phase stage of the auroral substorm process.

To achieve another object of the present invention, the present invention also provides an auroral substorm dynamic model based on neutral atom imaging measurement, including a simulation module and an emulation module, wherein
the simulation module is configured to establish a neutral atom imaging simulation equation for dynamic evolution of ion flux distribution of a ring current guided by ion pitch angle diffusion; and
the emulation module is configured to use the neutral atom imaging simulation equation, forward modeling neutral atom simulation images in an ecliptic plane corresponding to different ion pitch angle distribution functions during a geomagnetically quiet period and during an auroral substorm period to reproduce ring current ion flux distribution patterns in a growth phase stage and a recovery phase stage of an auroral substorm process.

The auroral substorm simulation method and dynamic model based on neutral atom imaging measurement provided in the present invention has the following advantages:
1. The auroral substorm simulation method and the auroral substorm dynamic model proposed in the present invention have a complete theoretical system, and a real and credible basis for multi-source measurement, allow emulation and reproduction, and have a prospect for visual direct measurement and verification;
2. The present invention reproduces a dynamic evolution process of a magnetospheric ring current during an auroral substorm period by ENA imaging simulation, and reproduces ring current ion flux distribution patterns in a growth phase stage and a recovery phase stage of an auroral substorm process, which lays a foundation for further research;
3. The ring current ion flux distribution patterns in the growth phase stage and the recovery phase stage of the auroral substorm process reproduced by the present invention are further used to monitor reduction of energetic neutral atom flux in the ring current region and enhancement of energetic neutral atom flux in an auroral zone region during a solar wind bow perturbation growth phase stage and corresponding AE index changes to evaluate an acceleration process of auroral substorm precipitated ions and analyze a corresponding acceleration mechanism;
4. The ring current ion flux distribution patterns in the growth phase stage and the recovery phase stage of the auroral substorm process reproduced by the present invention are further used to monitor energetic neutral atom flux changes in an auroral zone region and a ring current region, and monitor components and an energy spectrum of energy ions injected into the ring current during a magnetic field dipolarization process to evaluate precipitation loss and injection renewal of ring current energy ions during the auroral substorm process.
5. The ring current ion flux distribution patterns in the growth phase stage and the recovery phase stage of the auroral substorm process reproduced by the present invention are further used to evaluate a probability of continuous auroral substorms.

### BRIEF DESCRIPTION OF THE DRAWINGS

FIG. 1 is a schematic diagram of an auroral substorm model;

FIG. 2 illustrates ion flux distribution of an equatorial ring current;

FIG. 3 illustrates ion pitch angle distribution corresponding to different Kp indices;

FIG. 4(A) is a first distribution sequence plot of lunar-based ENA imaging emulation at a full moon;

FIG. 4(B) is a second distribution sequence plot of lunar-based ENA imaging emulation at a full moon;

FIG. 4(C) is a third distribution sequence plot of lunar-based ENA imaging emulation at a full moon;

FIG. 4(D) is a fourth distribution sequence plot of lunar-based ENA imaging emulation at a full moon;

FIG. 5(A) is a first distribution sequence plot of lunar-based ENA imaging emulation at a first quarter;

FIG. 5(B) is a second distribution sequence plot of lunar-based ENA imaging emulation at a first quarter;

FIG. 5(C) is a third distribution sequence plot of lunar-based ENA imaging emulation at a first quarter; and

FIG. 5(D) is a fourth distribution sequence plot of lunar-based ENA imaging emulation at a first quarter.

### DETAILED DESCRIPTION

The technical solution provided in the present invention is further described below in conjunction with embodiments.

As a main medium responsible for energy transfer in geomagnetic activities, energy ions are originally stored in a ring current region. When a solar wind particle stream (bow stroke) comes, a dynamic pressure at the top of a magnetosphere increases, and a magnetic field of the magnetosphere is stretched in a tail direction. Due to the conservation of a first adiabatic invariant, pitch angle diffusion occurs on the energy ions in the ring current region, and the energy ions deposit along magnetic lines of force towards an auroral region in a low altitude polar region, thereby triggering an auroral substorm. Meanwhile, a geomagnetic field infiltrated in a magnetotail plasma sheet constantly picks up energy ions from the solar wind particle stream. During a substorm recovery phase period, since the solar wind particle stream has passed, the dynamic pressure of the solar wind that deforms a magnetic shell layer decreases, and the magnetic field begins a dipolarization process. During a magnetic field dipolarization period, the magnetic field carries the energy ions picked up from the solar wind and injects them into a ring current. This allows the portion of energy ions lost in a loss cone during ion precipitation to be replenished. The above auroral substorm process can be dynamically monitored by ENA (energetic neutral atom) imaging in an ecliptic plane. Currently, visual telemetry of the phenomenon of magnetotail lobe reconnection cannot be implemented. However, both high velocity currents induced by magnetotail reconnection and groundward convection currents induced by magnetic field dipolarization contribute to ring current ion injection.

Usually, a substorm growth phase develops faster during energy ion pitch angle diffusion under solar wind pressure, while a substorm recovery phase driven by magnetic field dipolarization is slower. However, a high velocity current of energy ions generated by magnetotail reconnection can accelerate the process of the substorm recovery phase and even trigger a continuous series of substorms.

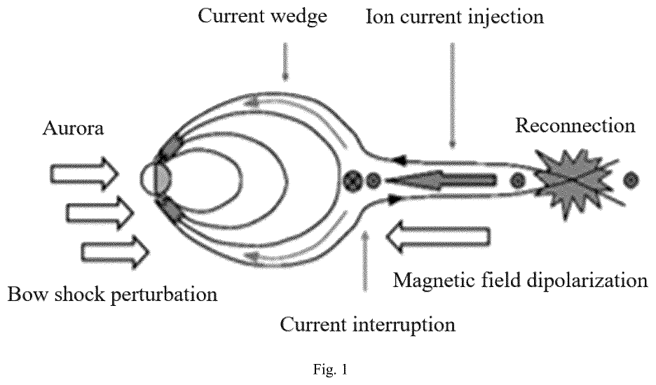

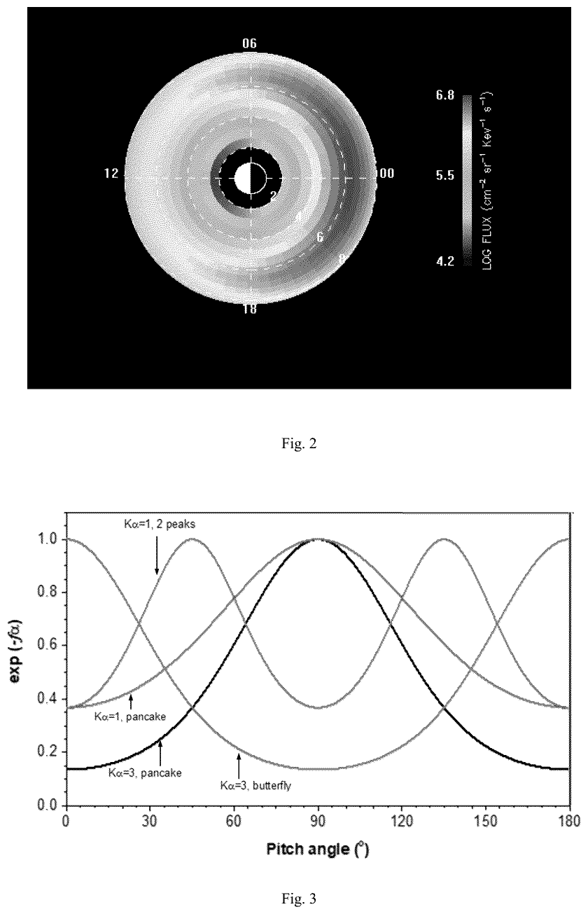

FIG. 1 shows a schematic diagram of an auroral substorm model. It includes: (1) 3 key node phenomena: “reconnection”, “current interruption”, and “aurora”; (2) 2 connection processes with energy ions as a transfer media: “ion current injection” and “current wedge”; and (3) 2 driving factors: “bow shock perturbation” and “magnetic field dipolarization”.

According to previous ENA imaging inversion logic, ENA images of all components and energy bands are usually converted into flux distribution of corresponding energy ions on an equatorial plane. By measuring energy ion flux distribution (both mass and energy spectra) of a ring current before a substorm, changes in the ion and mass spectra (e.g., changes in the composition of oxygen ions) during the substorm can be monitored to obtain source and acceleration information of the ions of different components in a targeted manner. Specifically, it is described below in conjunction with FIG. 1:
(1) During a geomagnetically quiet period, a large number of energy ions of different components and energy accumulate in a ring current region of a magnetosphere, and their flux distribution is substantially perpendicular to a local magnetic field. Therefore, mass and energy spectra of their spatial distribution can be acquired by ENA imaging measurement in an ecliptic plane.
(2) With solar wind bow shock perturbation, the Earth's magnetosphere is stretched and deformed in a tail direction, and like cumulonimbus clouds in meteorology, pitch angle diffusion (90° deviation) occurs in energy ions in a magnetospheric ring current, and at that time, current interruption occurs; the energy ions deposit along magnetic lines of force toward a low altitude polar region to form a current wedge, and trigger an auroral substorm in an auroral zone region; meanwhile, a geomagnetic field infiltrated in a magnetotail plasma sheet constantly picks up energy ions from a passing solar wind particle stream.
(3) After the bow shock passes through, the stretched magnetic field in the magnetosphere begins dipolarization in the magnetic field, and the magnetic field carries the energy ions picked up from solar wind and injects them into the ring current. This allows the portion of energy ions lost in a loss cone during ion precipitation to be replenished. Currently, ENA visual telemetry of the phenomenon of magnetotail lobe reconnection cannot be implemented at any location in space. However, both groundward high-velocity currents induced by magnetotail reconnection and groundward convection currents induced by magnetic field dipolarization will contribute to energy ion injection of magnetospheric ring currents. A high velocity current of energy ions generated by magnetotail reconnection may accelerate the process of the substorm recovery phase and even trigger a continuous series of substorms.

### Embodiment 1

This embodiment provides an auroral substorm simulation method based on neutral atom imaging measurement, including the following steps:
establishing a neutral atom imaging simulation equation for dynamic evolution of ion flux distribution of a ring current guided by ion pitch angle diffusion;

using the neutral atom imaging simulation equation, forward modeling neutral atom simulation images in an ecliptic plane corresponding to different ion pitch angle distribution functions during a geomagnetically quiet period and during an auroral substorm period to reproduce ring current ion flux distribution patterns in a growth phase stage and a recovery phase stage of an auroral substorm process.

After forward modeling neutral atom simulation images in an ecliptic plane corresponding to different ion pitch angle distribution functions during a geomagnetically quiet period and during an auroral substorm period, the method further includes the following steps:

In a quiet state before the occurrence of a substorm, i.e., during a geomagnetically quiet period, an ion pitch angle does not diffuse, and flux distribution, mass and energy spectra of energy ions stored in a ring current region are measured and evaluated by using the neutral atom simulation images in the ecliptic plane.

Based on measurement results of components, the energy spectrum and flux distribution of the energy ions in the ring current region before the occurrence of the substorm, reduction of ENA flux in the ring current region and enhancement of ENA flux in an auroral zone region during a solar wind bow perturbation growth phase stage and corresponding AE index changes are monitored to evaluate an acceleration process of substorm precipitated ions and analyze a corresponding acceleration mechanism.

During a stage in the substorm development process after the solar wind passes through, i.e., during the recovery phase stage of the auroral substorm process, by using neutral atom images, ENA flux changes in an auroral zone region and the ring current region are monitored, components and an energy spectrum of energy ions injected into the ring current during a magnetic field dipolarization process are monitored, and precipitation loss and injection renewal of ring current energy ions during the substorm process are evaluated.

A probability of continuous auroral substorms is evaluated based on a ring current energy ion storage state, i.e., a ring current ion flux distribution pattern, in the substorm recovery phase stage.

The present invention forward models an ENA emission distribution pattern in a ring current region during dynamic evolution of an auroral substorm by ENA imaging simulation, and proves the above method by using previous ENA measurement data.

### I. ENA Imaging Simulation of Dynamic Evolution of a Ring Current

### (1) Simulation Equation

Counts C(δ, ε), elevation angle δ and azimuth angle ε recorded in each pixel of ENA images are expressed in a simulation equation:

$$\\ \begin{matrix}C ( δ , ε ) = \int Δ E Δ T Δ Ω {j}_{ion} ( L , φ , θ , E , α ) A ( δ , ε ) σ ( E ) n ( r , φ , θ ) dV . & ( 1 )\end{matrix}$$

wherein ΔE is an ion energy channel width; ΔT is an integration time of the pixel; ΔΩ is a solid angle of a volume element pointing to the pixel with the elevation angle δ and the azimuth angle ε; Jᵢₒₙ(L, φ, θ, E, α) is an ion differential flux at the integration volume element; A(δ, ε) is a response function of a detector; σ(E) is a charge-exchange cross-section; n(r, φ, θ) is an exosphere neutral atom density, where r is a geocentric distance, φ is a local time, θ is a magnetic latitude; and dV is a volume element integral along a line-of-sight direction of the detector.

An ion flux in a ring current region can be expressed as:

$$\\ \begin{matrix}{j}_{ion} ( L , φ , θ , E , α ) = {ej}_{max 0}^{{}_{} eq} ( φ , L , {α}_{eq} ) \frac{E}{{E}_{max 0}} {( 1 + \frac{E}{κ {E}_{max 0}} )}^{- κ - 1} & ( 2 )\end{matrix}$$

where L is a magnetic shell parameter, φ is a local time, θ is a magnetic latitude, E is energy, α is an ion pitch angle within a magnetospheric neutral atom image emitter element, α_{eg} is a pitch angle of equatorial ions; κ=5.5; and E_{max 0} is an initial value of energy at which a ring current ion flux is maximum;

e=(1+1/κ)^{κ+1}˜2.962;

$${j}_{max 0}^{eq} ( φ , L , {α}_{eq} ) = {J}_{0}^{eq} exp \{ - ( {f}_{φ} + {f}_{L} + {f}_{α} ) \} \qquad ( 3 )$$

Here, j_{max 0}^{eq}(φ, L, α_{eq})=6×10⁶ cm⁻²sr ⁻¹KeV⁻¹s^{31 1}
φ is a local time;
a local time distribution function of the ring current ion flux f_{φ} is expressed as:

$${f}_{φ} = ξ [ 1 - cos ( φ - {φ}_{s} ) ] \qquad ( 4 )$$

where φ=180°, ζ=0.73, and here the local time φ of the ring current ion flux is in symmetric distribution.

L is a magnetic shell parameter, and a magnetic shell parameter distribution function f_{L} of the ring current ion flux is expressed as:

$${f}_{L} = \{ \begin{matrix}{{γ}_{1} ( L - {L}_{11} )}^{2} , & L < {L}_{11} \\ γ ( L - {L}_{11} ) , & {L}_{11} \leq L \leq {L}_{22} \\ {{γ}_{2} ( L - {L}_{22} )}^{2} + γ ( {L}_{22} - {L}_{11} ) , & L > {L}_{22}\end{matrix} \qquad ( 5 )$$

where L₁₁ is a first boundary value of a ring current, L₂₂ is a second boundary value of the ring current, γ₁ is a first model parameter, γ₂ is a second model parameter, and γ is a third model parameter, wherein L₁₁ and L₂₂ are calculated by formula (6):

$${L}_{b} = \frac{122 - 10 {K}_{P}}{24 - 7.3} \qquad ( 6 )$$

where L_{b} is a boundary value of the ring current, and Kₚ is a geomagnetic activity index; that is:

$${L}_{11} = \frac{122 - 10 {K}_{p 11}}{24 - 7.3} ;$$

$${L}_{22 =} \frac{122 - 10 {K}_{p 22}}{24 - 7.3} ,$$

where Kₚ₁₁ is a first geomagnetic activity index, Lₚ₂₂ is a second geomagnetic activity index, Lₚ₁₁=5.5, and Kₚ₂₂=0.
therefore, L₁₁≈4.01, L₂₂≈7.3, and the model parameters take values as follows: γ₁=0.53, γ=1.16, γ₂=0.88.
the ion pitch angle α within a magnetospheric ENA emitter element is expressed by the pitch angle α_{eq} of equatorial ions, and the pitch angle distribution function f_{α} of ring current ions is expressed as:

$${f}_{α} = \{ \begin{matrix}{K}_{α} {cos}^{2} {α}_{eq} , & ( {K}_{α} = 3 ) \\ {K}_{α} {cos}^{2} {α}_{eq} , & ( {K}_{α} = 1 ) \\ {K}_{α} {cos}^{2} 2 {α}_{eq} , & ( {K}_{α} = 1 ) \\ {K}_{α} {sin}^{2} {α}_{eq} , & ( {K}_{α} = 3 )\end{matrix} \qquad ( 7 )$$

Here, dynamical evolution of an auroral substorm is simulated in FIG. 3, with a distribution curve of pitch angles from “pancake-type” to “butterfly-type”.

An ENA imager has a minimum energy channel of 4 keV and therefore does not directly record background neutral gas (≤10⁶ K). The ENA imager records the ENA images after charge exchange between energy ions precipitated into an auroral region by an equatorial ring current and low-energy neutral atoms evaporating from an exosphere.

Neutral hydrogen provided by a modified Chamberlain model proposed in the paper “Geocoronal imaging with dynamics explorer” by Rairden et al. is too low in density to be applied to geomagnetic environments of auroral substorms. If a radial flux of neutral atoms is assumed to be conserved during a strong geomagnetic storm, we can add an additional item to the Chamberlain model such that the density n (r, φ, θ) may be expressed as:

$$n ( r , φ , θ ) = {n}_{0} ( exp ( 17.5 exp ( - 1.5 r ) - \frac{r}{1.46 ( 1 - 0.3 sin θ cos φ} ) + {( \frac{{a}_{0}}{r} )}^{2} ) \qquad ( 8 )$$

where r is a geocentric distance (in units of exosphere height RE), a₀=1.78, and n₀=1600 cm⁻³ is a neutral density constant. This model well fits an annual mean hydrogen density under solar maximum conditions obtained by measurement in the paper “Monte carlo models for the terrestrial exosphere over a solar cycle” by Tinsley et al. This result is also applicable to an auroral substorm period.

### (2) Emulation Result

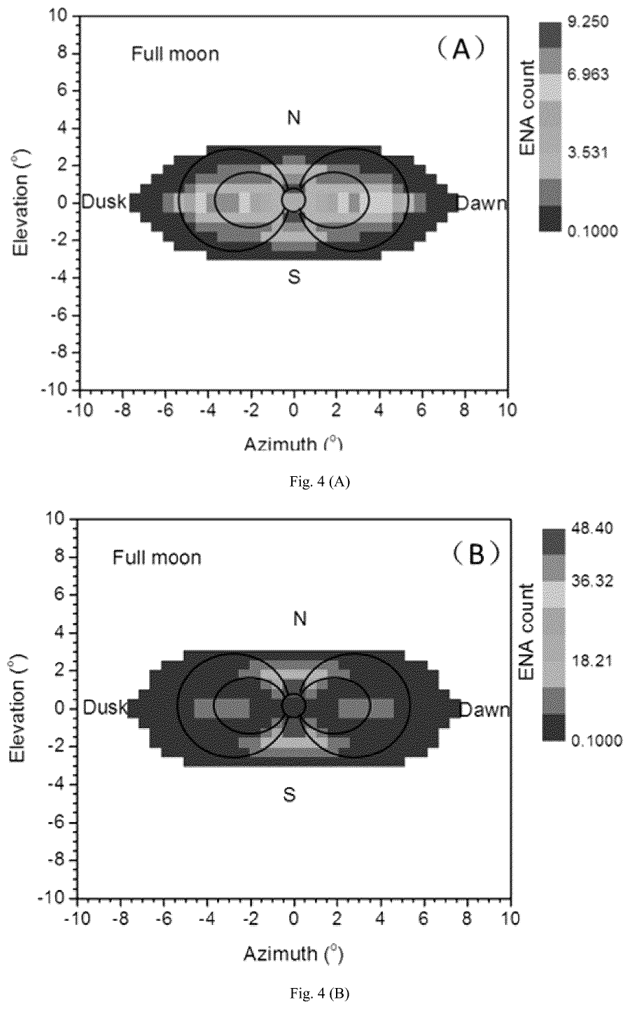

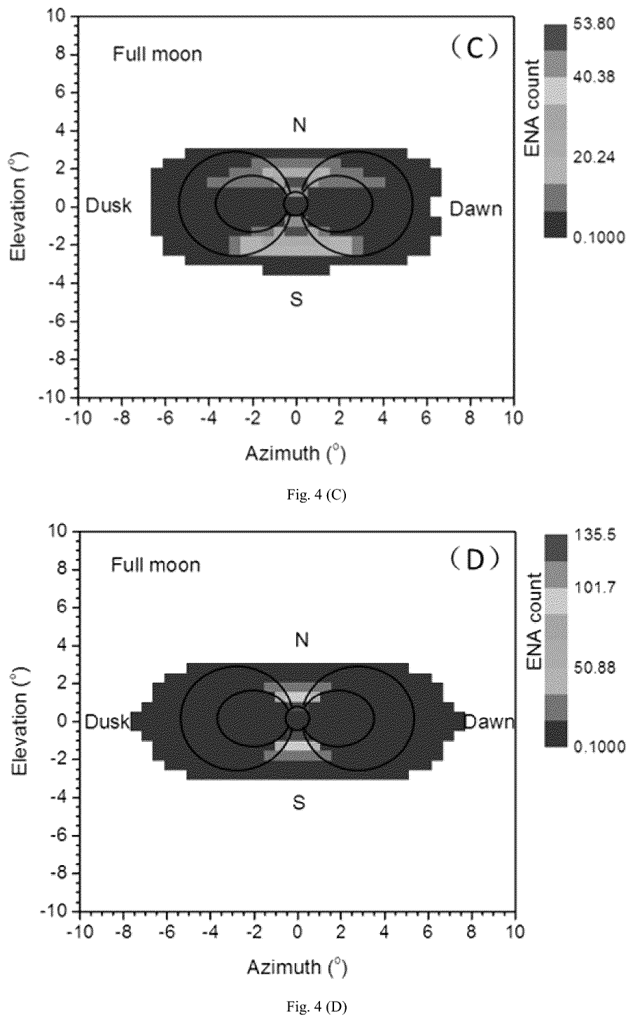

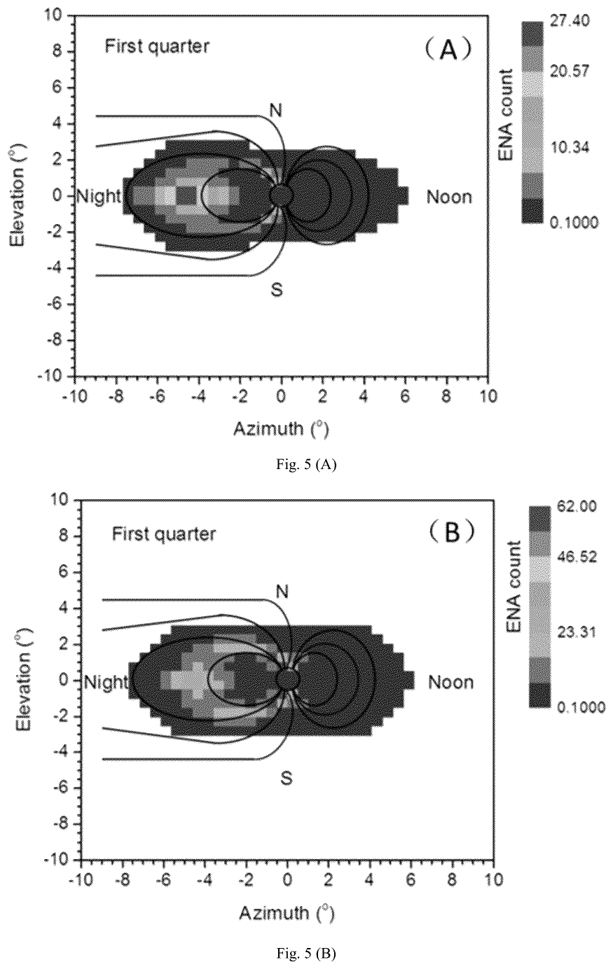

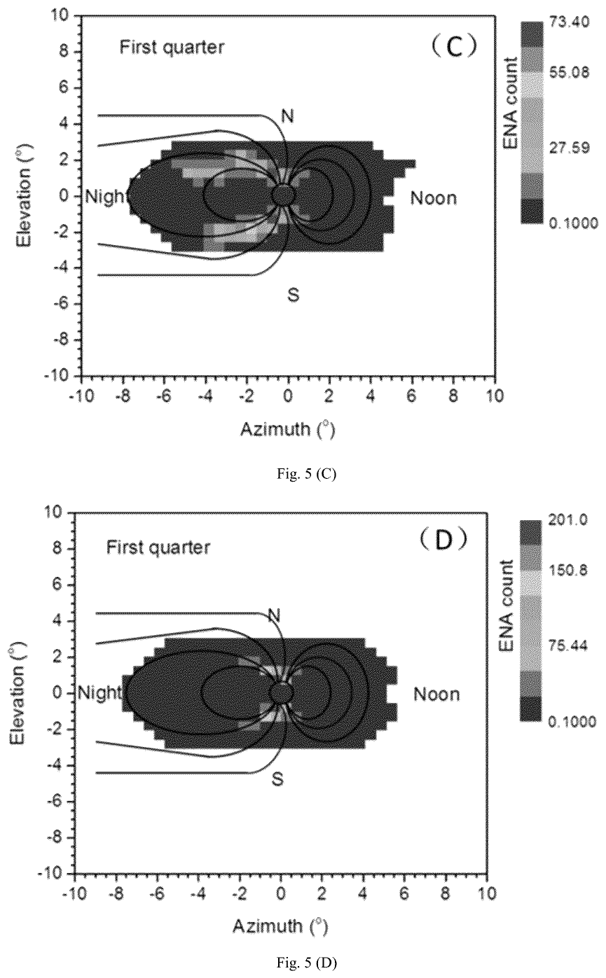

We simulate a dynamical process of an auroral substorm by using ion pitch angle diffusion. As illustrated by emulation sequence images from FIG. 4(A) to FIG. 4(D) and from FIG. 5(A) to FIG. 5(D) in a positive sequence, we simulate an auroral substorm growth phase during a pitch angle diffusion growth process by using lunar-based full moon and first quarter positions in the ecliptic plane; and in an inverse order of the emulation sequence images, i.e., from FIG. 4(D) to FIG. 4(A) and from FIG. 5(D) to FIG. 5(A), we can simulate an auroral substorm recovery phase. FIG. 3 illustrates different distribution patterns corresponding to ion pitch angle diffusion.

FIGS. 4(A) to 4(D) are first to fourth distribution sequence plots of lunar-based ENA imaging emulation at a full moon, wherein the substorm process is illustrated from FIG. 4(A) to FIG. 4(D).

FIGS. 5(A) to 5(D) are first to fourth emulation distribution sequence plots of lunar-based ENA imaging at a first quarter, wherein a substorm process is illustrated from FIG. 5(A) to FIG. 5(D).

During a geomagnetically quiet period, in FIGS. 4(A) and 5(A), pitch angles of ring current energy ions are mostly 90° (pancake-type distribution), and a resulting ENA emission source is located in an equatorial ring current region, propagates only in the ecliptic plane, and attenuates very slowly. On a lunar orbit at about 60 RE, an ENA imager can obtain about 600-700 counts in 3-minute integration time. Maximum ENA event counts for a single pixel are 10-30, as seen in Table 1. A first quarter image of FIG. 5(A) shows that ENAs are mostly distributed around L ≥6 and have a tendency to expand along magnetic lines of force. An equatorial circular current is far from the Earth and has a lower density of neutral gases, resulting in a low global energetic neutral index (GENI) in the paper “Terrestrial energetic neutral atom emissions and the ground-based geomagnetic indices: Implications from IBEX observations” by Ogasawara et al. Almost no ENA emission events were measured in the auroral region.

TABLE 1
ENA count statistics:

| Kₚ = 3 | Full Moon | | First quarter | |
|---|---|---|---|---|
| K_{α} & shape | Maximum | Sum | Maximum | Sum |
| (Shape) | (maximum) | (Sum) | (maximum) | (Sum) |
| 3 & pancake | 9.23 | 600.42 | 27.32 | 702.65 |
| (pancake type) | | | | |
| 1 & pancake | 48.40 | 1633.84 | 61.84 | 1661.70 |
| (pancake type) | | | | |
| 1 & 2 peaks (bimodal | 53.77 | 1739.67 | 73.23 | 1807.38 |
| distribution) | | | | |
| 3 & butterfly | 135.42 | 2140.55 | 200.04 | 2201.84 |
| (butterfly type) | | | | |

With pitch angle diffusion, the ENA emission source begins to shift along the magnetic lines of force towards a low-altitude high-latitude polar region, and magnetic flux tubes converge in a low-altitude auroral region. Since the neutral gas density in the auroral region is much larger than that in the equatorial ring current region, ENA emission from the auroral region is rapidly enhanced, and its global energetic neutral index (GENI) is correspondingly increased, as shown in FIGS. 4(B) to 4(D), and 5(B) to 5(D). After pitch angle diffusion, ring current energy ions with a continuous pitch angle distribution in the auroral region can lead to almost omnidirectional ENA emission. Here, we define ENA emission enhancement in the auroral region as ENA aurora.

As the pitch angle further diffuses, the flux of energetic ions perpendicular to the magnetic field decreases, and the ENA emission source in the equatorial ring current starts to decrease, but the GENI further increases, as shown in FIGS. 4(C) and 5(C).

When the pitch angle eventually diffuses into butterfly-type distribution (energy ions with the pitch angle perpendicular to the magnetic lines of force are minimized), the ENA emission source substantially shifts to a high-latitude auroral zone region, and the global energetic neutral index (GENI) also reaches a maximum value. ENA emulation counts also increase rapidly with increasing diffusion of the ion pitch angle, and both ENA event counts for a single pixel and total counts increase by about an order of magnitude, as shown in Table 1.

During the substorm recovery phase period (in a reverse order of evolution in FIGS. 4 and 5, i.e., from FIG. 4(D) to FIG. 4(A) and from FIG. 5(D) to FIG. 5(A)), the pitch angle distribution changes from the butterfly type back to the pancake type. Lunar-based ENA imaging measurements of the entire substorm process not only feature the GENI, but also allow the evolution process of the ring current energy ion flux to be monitored visually through the distribution pattern of the ENA emission source.

### II. Observational Basis for a Substorm Macro-Model

In previous ENA observations, such as ENA observations in the paper “Ener-getic neutral atom imaging by the Astrid mi-crosatellite”, “IMAGE mission over-view”, “The energetic NeUtral Atom Detector Unit (NUADU) for China's Double Star Mission and its Calibration” and “The two wide-angle imaging neutral-atom spectrometers (twins) nasa mis-sion-of-opportunity”, orbit inclinations were large. Except for IBEX satellites operating in the ecliptic plane, there were few ENA signals directly from ring currents. ENA brightening signals substantially originated from low-altitude polar regions, and we call them ENA aurora. However, according to “The causal sequence investigation of the ring current ion-flux increasing and the magnetotail ion injection during a major storm” by Lu L et al and “Close up observation and inversion of low-altitude ENA emissions during a substorm event” by Lu L et al, measurements and inverse modeling of an ENA auroral evolution sequence by NUADU/TC-2, in combination with in-situ measurements from other multi-satellite systems, disclosed many features of ring current evolution. According to “First IBEX observations of the terrestrial plasma sheet and a possible disconnection event” by McComas, D. J. et al, IBEX-Hi operating on the ecliptic plane even collected ENA telemetry signals directly originating from a magnetospheric ring current region during a substorm/quiet period.

### (1) Multi-satellite Joint Observation of Causal Timing of Substorm Events

According to the paper “The causal sequence investigation of the ring current ion-flux increasing and the magnetotail ion injection during a major storm” by Lu L et al, a high-time-resolution neutral atom imager on a binary star system fortunately recorded a strong geomagnetic storm process on May 15, 2005. Neutral atom imaging measurement inversion data indicated that an evolution process of a strong geomagnetic storm ring current was closely related to two series of substorms. By comparing ENA imaging measurement inversion data with an in-situ ion flux and magnetic field measurement data from cluster satellites LANL and GOES in a geosynchronous orbit, we found that the three sets of data had some interrelated covariation properties. A magnetic field response of night-side substorms in the geosynchronous orbit preceded a geomagnetic index response recorded by a ground station. Observations showed that ENA auroral brightening occurred in a substorm growth phase stage of a tail-direction stretching of the magnetic lines of force, rather than after magnetic field groundward dipolarization. This indicated that energy ions causing the ENA auroral brightening were stored in a ring current region beforehand. The above research work does not support a neutral line model in which magnetotail reconnection triggers a substorm. Ion injection or convection events occurring after this just involved particle energy prepared for a subsequent substorm.

### (2) Azimuth Evolution of ENA Aurora

According to the paper “Close up observation and inversion of low-altitude ENA emissions during a substorm event” by Lu L et al, on Nov. 12, 2004, TC-2/NUADU obtained an ENA image, the time resolution of which is currently still highest, by using close-up measurements at perigee, and carried out inverse modeling to obtain a result of equatorial ring current ion flux distribution accordingly. Based on a ring current ion flux obtained by inverse modeling from the ENA image projected onto the equatorial plane, we found that ENA auroral brightening was often accompanied by an eastward drift. Conversely, ENA aurora drifted westward as it weakened. As a result of the Earth's rotation, the order of response of tail-direction stretching of a magnetospheric magnetic field was from east to west, while the order of response of dipolarization of the magnetic field was opposite, from west to east. However, the geomagnetic field variations described above represents a regional feature, and it is difficult to obtain evidence for in-situ measurements suitable for geomagnetic field variations. Nevertheless, the above observation results are indirect evidence that magnetic field perturbations in the magnetosphere trigger substorms.

### (3) Examples of ENA Telemetry of Ring Currents during Quiet and Substorm Periods

According to the paper “First IBEX observations of the terrestrial plasma sheet and a possible disconnection event” by McComas et al, IBEX-Hi ENA scanned images from the periapsis and apogee of orbits 51 and 52 showed that there were indeed ENA signals from a magnetotail direction during a geomagnetically quiet period. These ENA signals and flux variations may serve as examples of ring current ion flux telemetry during geomagnetic substorm and quiet periods.

These IBEX-Hi ENA scanned images, with a crack at about −10 Re of the magnetotail, were originally thought to be remote sensing images of a plasma sheet discontinuity event. However, differential fluxes of ENAs on both sides of the crack were similar, indicating that emission mechanisms of the ENAs on both sides were same. During a geomagnetically quiet period, energetic ions in a ring current region were constrained by a magnetic field, and their pitch angle was about 90°. ENAs produced by exchange of charge between the energetic ions and surrounding neutral gas propagated only in the ecliptic plane and attenuated slowly. According to an ENA counting image in the paper “First IBEX observations of the terrestrial plasma sheet and a possible disconnection event” by McComas et al, it can be seen that scanning covered most of the magnetotail in 7 days, from Oct. 26 to Nov. 2, 2009. The figure showed that an ENA signal rapidly disappeared at dusk on Oct. 29, 2009, although a field of view of IBEX had been facing a plasma sheet until November 2 when it entered the magnetotail. Taking into account positional errors due to the width of the IBEX field of view, we believe that the ENAs measured by IBEX-hi should be emitted by a ring current at a distance of about 50 RE.

According to the paper “Terrestrial energetic neutral atom emissions and the ground-based geomagnetic indices: Implications from IBEX observations” by McComas et al, IBEX-Hi observed in the 51th orbit from 21:21 UT on Oct. 27, 2009 to 13:40 UT on Oct. 29, 2009 that in a magnetotail region between −4Re and −12Re, the ENA differential flux had a recess descending from 500 cm-2sr-1KeV-1s-1 down to 250 cm-2sr-1KeV-1s-1. A substorm occurred on Oct. 28, 2009. An AE index began to grow at 3:45 (AE=22 nT), reached a maximum value at 11:15 (AE=281 nT), and recovered to tranquility at 23:05 (AE=44 nT). It lasted for about a full day. During the substorm, a pitch angle of energetic ions in a ring current diffused, and ENAs propagating in the ecliptic plane decreased, leading to an observational artifact of plasma sheet discontinuity. Before midnight on the 28th, the geomagnetic activity became quiet again, and a scanning field of view of IBEX-Hi may still cover the ring current at a distal end of the magnetotail, so ENA enhancement signals were measured. That is, ENA signals with gaps measured by IBEX-Hi at the 51th orbit were all generated by parent energy ions of the ring current. During a geomagnetically quiet period, most of the parent energy ions had a pitch angle of about 90°.

### Embodiment 2

ENA imaging measurements in the ecliptic plane can obtain information on ring current energy ion distribution information during a geomagnetically quiet period, which makes it possible to perform global dynamic monitoring of an auroral substorm process. We create a dynamic model about an auroral substorm by dynamic simulation of ENA imaging measurement of a substorm event. Based on the possibility of visual telemetry of ring current ion flux, we propose an auroral substorm dynamic model dominated by solar wind dynamic pressure, to execute the auroral substorm simulation method based on neutral atom imaging measurement provided in Embodiment 1.

The auroral substorm dynamic model based on neutral atom imaging measurement provided in this embodiment includes a simulation module and an emulation module, wherein
the simulation module is configured to establish a neutral atom imaging simulation equation for dynamic evolution of ion flux distribution of a ring current guided by ion pitch angle diffusion; and
the emulation module is configured to, using the neutral atom imaging simulation equation, forward model neutral atom simulation images in an ecliptic plane corresponding to different ion pitch angle distribution functions during a geomagnetically quiet period and during an auroral substorm period to reproduce ring current ion flux distribution patterns in a growth phase stage and a recovery phase stage of an auroral substorm process.

It can be seen from the above specific description of the present invention:
1. The auroral substorm simulation method and the auroral substorm dynamic model proposed in the present invention have a complete theoretical system, and a real and credible basis for multi-source measurement, allow emulation and reproduction, and have a prospect for visual direct measurement and verification;
2. The present invention reproduces a dynamic evolution process of a magnetospheric ring current during an auroral substorm period by ENA imaging simulation, and reproduces ring current ion flux distribution patterns in a growth phase stage and a recovery phase stage of an auroral substorm process, which lays a foundation for further research;
3. The ring current ion flux distribution patterns in the growth phase stage and the recovery phase stage of the auroral substorm process reproduced by the present invention are further used to monitor reduction of energetic neutral atom flux in the ring current region and enhancement of energetic neutral atom flux in an auroral zone region during a solar wind bow perturbation growth phase stage and corresponding AE index changes to evaluate an acceleration process of auroral substorm precipitated ions and analyze a corresponding acceleration mechanism;
4. The ring current ion flux distribution patterns in the growth phase stage and the recovery phase stage of the auroral substorm process reproduced by the present invention are further used to monitor energetic neutral atom flux changes in an auroral zone region and a ring current region, and monitor components and an energy spectrum of energy ions injected into the ring current during a magnetic field dipolarization process to evaluate precipitation loss and injection renewal of ring current energy ions during the auroral substorm process.
5. The ring current ion flux distribution patterns in the growth phase stage and the recovery phase stage of the auroral substorm process reproduced by the present invention are further used to evaluate a probability of continuous auroral substorms.

Finally, it should be noted that the above embodiments are only used for describing instead of limiting the technical solutions of the present invention. Although the present invention is described in detail with reference to the embodiments, persons of ordinary skill in the art should understand that modifications or equivalent substitutions of the technical solutions of the present invention should be encompassed within the scope of the claims of the present invention so long as they do not depart from the spirit and scope of the technical solutions of the present invention.

1. An auroral substorm simulation method based on neutral atom imaging measurement, comprising the following steps:
establishing a neutral atom imaging simulation equation for dynamic evolution of ion flux distribution of a ring current guided by ion pitch angle diffusion; and
using the neutral atom imaging simulation equation, forward modeling neutral atom simulation images in an ecliptic plane corresponding to different ion pitch angle distribution functions during a geomagnetically quiet period and during an auroral substorm period to reproduce ring current ion flux distribution patterns in a growth phase stage and a recovery phase stage of an auroral substorm process.

2. The auroral substorm simulation method based on neutral atom imaging measurement according to claim 1, wherein establishing a neutral atom imaging simulation equation for dynamic evolution of ion flux distribution of a ring current guided by ion pitch angle diffusion specifically comprises the following steps: expressing counts C (δ, ε), elevation angle δ and azimuth angle ε recorded in each pixel of neutral atom images, in the neutral atom image simulation equation:
$$C ( δ , ε ) = \int Δ E Δ T Δ Ω {j}_{i on} ( L , φ , θ , E , α ) A ( δ , ε ) σ ( E ) n ( r , φ , θ ) dV ,$$
wherein ΔE is an ion energy channel width; ΔT is an integration time of the pixel; ΔΩ is a solid angle of a volume element pointing to the pixel with the elevation angle δ and the azimuth angle ε; Jᵢₒₙ(L, φ, θ, E, α) is an ion differential flux at the integration volume element; A(δ, ε) is a response function of a detector; σ(E) is a charge-exchange cross-section; n(r, φ, θ) is an exosphere neutral atom density, where r is a geocentric distance, φ is a local time, θ is a magnetic latitude; dV is a volume element integral along a line-of-sight direction of the detector, L is a magnetic shell index, E is energy, and α is an ion pitch angle within a magnetospheric neutral atom image emitter element.

3. The auroral substorm simulation method based on neutral atom imaging measurement according to claim 2, wherein the ion differential flux Jᵢₒₙ(L, φ, θ, E, α) at the integration volume element is:
$${j}_{i on} ( L , φ , θ , E , α ) = {ej}_{max 0}^{eq} ( φ , L , {α}_{eq} ) \frac{E}{{E}_{max 0}} {( 1 + \frac{E}{κ {E}_{max 0}} )}^{- κ - 1} ,$$
where L is a magnetic shell parameter, φ is a local time, θ is a magnetic latitude, E is energy, α is an ion pitch angle within a magnetospheric neutral atom image emitter element, α_{eq} is a pitch angle of equatorial ions; κ=5.5; and E _{max 0} is an initial value of energy at which a ring current ion flux is maximum;
e=(1+1/κ)^{κ+1}.
$${j}_{max 0}^{eq} ( φ , L , {α}_{eq} ) = {J}_{0}^{eq} exp \{ - ( {f}_{φ} + {f}_{L} + {f}_{α} ) \} ,$$
where j_{max 0}^{eq}(φ, L, α_{eq})=5×10⁶ cm⁻²sr⁻¹KeV⁻¹s⁻¹, and J₀^{eq} is an equatorial ion flux;
f_{φ} is a local time distribution function of the ring current ion flux:
$${f}_{φ} = ξ [ 1 - cos ( φ - {φ}_{s} ) ] ,$$
where φₛ=180°, ζ=0.73, and the local time φ of the ring current ion flux is in symmetric distribution;
f_{L} is a magnetic shell parameter distribution function of the ring current ion flux:
$${f}_{L} = \{ \begin{matrix}{{γ}_{1} ( L - {L}_{11} )}^{2} , & L < {L}_{11} \\ γ ( L - {L}_{11} ) , & {L}_{11} \leq L \leq {L}_{22} \\ {{γ}_{2} ( L - {L}_{22} )}^{2} + γ ( {L}_{22} - {L}_{11} ) , & L > {L}_{22}\end{matrix} ,$$
where L is a magnetic shell parameter, L₁₁ is a first boundary value of a ring current, L₂₂ is a second boundary value of the ring current, γ₁ is a first model parameter, γ₂ is a second model parameter, and γ is a third model parameter, where
$${L}_{11} = \frac{122 - 10 {K}_{p 11}}{24 - 7.3} ;$$
$${L}_{22 =} \frac{122 - 10 {K}_{p 22}}{24 - 7.3} ,$$
where Kₚ₁₁ is a first geomagnetic activity index, Kₚ₂₂ is a second geomagnetic activity index, Kₚ₁₁=5.5, and Kₚ₂₂=0;
f_{α} is a pitch angle distribution function of ring current ions;
$${f}_{α} = \{ \begin{matrix}{K}_{α} {cos}^{2} {α}_{eq} , & ( {K}_{α} = 3 ) \\ {K}_{α} {cos}^{2} {α}_{eq} , & ( {K}_{α} = 1 ) \\ {K}_{α} {cos}^{2} 2 {α}_{eq} , & ( {K}_{α} = 1 ) \\ {K}_{α} {sin}^{2} {α}_{eq} , & ( {K}_{α} = 3 )\end{matrix} ,$$
where the ion pitch angle α within a magnetospheric neutral atom image emitter element is expressed by the pitch angle α_{eg} of equatorial ions.

4. The auroral substorm simulation method based on neutral atom imaging measurement according to claim 3, wherein the first model parameter γ₁ takes a value of 0.53, the second model parameter γ₂ takes a value of 0.88, and the third model parameter γ takes a value of 1.16.

5. The auroral substorm simulation method based on neutral atom imaging measurement according to claim 2, wherein the exosphere neutral atom density n(r, φ, θ) is:
$$n ( r , φ , θ ) = {n}_{0} ( exp ( 17.5 exp ( - 1.5 r ) - \frac{r}{1.46 ( 1 - 0.3 sin θ cos φ} ) + {( \frac{{a}_{0}}{r} )}^{2} )$$
wherein a radial flux of neutral atoms is set to be conserved during strong geomagnetic storms, n₀ is a neutral density constant and takes a value of 1600 cm⁻³, exp represents an exponential function, r is a geocentric distance, the geocentric distance r is in units of exosphere height R_{E}, θ is a magnetic latitude, and φ is a local time, with an intermediate value a₀=1.78.

6. The auroral substorm simulation method based on neutral atom imaging measurement according to claim 2, wherein the neutral atom images are recorded by an energetic neutral atom imager;
the energetic neutral atom imager records the neutral atom images after charge exchange between energy ions precipitated into an auroral region by an equatorial ring current and low-energy neutral atoms evaporating from an exosphere; and
a minimum energy channel of the energetic neutral atom imager is 4 keV.

7. The auroral substorm simulation method based on neutral atom imaging measurement according to claim 1, wherein after forward modeling neutral atom simulation images in an ecliptic plane corresponding to different ion pitch angle distribution functions during a geomagnetically quiet period and during an auroral substorm period, the method further comprises the following steps:
measuring and evaluating flux distribution, mass and energy spectra of energy ions stored in a ring current region by using the neutral atom simulation images in the ecliptic plane during the geomagnetically quiet period; and
based on results of measuring and evaluating the flux distribution, mass and energy spectra of the energy ions stored in the ring current region by using the neutral atom simulation images in the ecliptic plane during the geomagnetically quiet period, monitoring reduction of energetic neutral atom flux in the ring current region and enhancement of energetic neutral atom flux in an auroral zone region during a solar wind bow perturbation growth phase stage and corresponding AE index changes to evaluate an acceleration process of auroral substorm precipitated ions and analyze a corresponding acceleration mechanism.

8. The auroral substorm simulation method based on neutral atom imaging measurement according to claim 1, wherein after forward modeling neutral atom simulation images in an ecliptic plane corresponding to different ion pitch angle distribution functions during a geomagnetically quiet period and during an auroral substorm period, the method further comprises the following step:
during the recovery phase stage of the auroral substorm process, by using neutral atom images, monitoring energy neutral atom flux changes in an auroral zone region and a ring current region, and monitoring components and an energy spectrum of energy ions injected into the ring current during a magnetic field dipolarization process to evaluate precipitation loss and injection renewal of ring current energy ions during the auroral substorm process.

9. The auroral substorm simulation method based on neutral atom imaging measurement according to claim 1, wherein after forward modeling neutral atom simulation images in an ecliptic plane corresponding to different ion pitch angle distribution functions during a geomagnetically quiet period and during an auroral substorm period, the method further comprises the following step:
evaluating a probability of continuous auroral substorms based on a ring current ion flux distribution pattern in the recovery phase stage of the auroral substorm process.

10. An auroral substorm macroscopic model based on neutral atom imaging measurement, wherein comprising a simulation module and an emulation module, wherein
the simulation module is configured to establish a neutral atom imaging simulation equation for dynamic evolution of ion flux distribution of a ring current guided by ion pitch angle diffusion; and
the emulation module is configured to, using the neutral atom imaging simulation equation, forward model neutral atom simulation images in an ecliptic plane corresponding to different ion pitch angle distribution functions during a geomagnetically quiet period and during an auroral substorm period to reproduce ring current ion flux distribution patterns in a growth phase stage and a recovery phase stage of an auroral substorm process.
